(19) United States
(12) Patent Application Publication
(10) Pub. No.: US 2001/0013732 A1
(43) Pub. Date: Aug. 16, 2001

(54) ANTI-VIBRATION ELECTRIC MOTOR HAVING OUTER ROTOR STABLY SUPPORTED AT TWO ENDS

(76) Inventor: CHUN-PU HSU, TAIPEI (TW)

Correspondence Address: BACON & THOMAS, P.L.L.C, ATTN: BENJAMIN E. URCIA, 625 SLATERS LANE- 4TH FLOOR, ALEXANDRIA, VA, 22314-1176, US

(21) Appl. No.: 09/272,497

(22) Filed: Mar. 19, 1999

(51) Int. Cl. H02K 5/16

(52) U.S. Cl. 310/90

(57) ABSTRACT

An electric motor includes: an inner stator coaxially mounted on a central stem of a stator holder, an outer rotor having a cylinder member secured with a magnetic conductor in the cylinder member and circumferentially disposed about the inner stator, with the open-end periphery of the cylinder member of the outer rotor stably rotatably supported on a bearing annularly retained on the stator holder, a driving shaft coaxially secured on a central portion of the outer rotor and rotatably mounted in a housing combined with the stator holder, thereby forming an electric motor stably rotated for preventing vibrational shock in order for making a motor with higher torque, house power, stability and efficiency.

### BACKGROUND OF THE INVENTION

A conventional brush-free electric motor as shown in FIG. 11 includes: an outer rotor R formed as cylindrical shape and having a closed-end wall R1 secured with a driving shaft T thereon, an inner stator S having magnetizing windings C wound on a laminated core L secured to a base B, a plurality of permanent magnets M fixed on an inside wall of the cylindrical outer rotor R, with the shaft T rotatably mounted in a central hole H in the stator S and the base B, whereby upon powering and magnetizing of the windings C on the inner stator S, the stator S will produce a magnetic field to interact with the magnetic field of the permanent magnets M on the outer rotor R and the outer rotor R will be rotated to output a torque through the shaft T.

However, such a conventional electric motor with outer rotor R has the following drawbacks:

1. The outer rotor R has an open-ended periphery R2, not supported by any means, thereby easily causing vibrational shock especially when rotating under higher magnetic field and higher centrifugal force, and possibly causing noise or damage.

2. Due to the vibrational defect, the conventional motor with outer rotor is not suitable for making motor of high horsepower and high torque, thereby limiting the industrial uses to be, for instance, merely a miniature motor for tape recorder, disk drive, cooling fan and other motors of low horsepower and low torque.

3. If inferentially laying down the motor as vertically erected as shown in FIG. 11 to be horizontally positioned (not shown) by aligning the shaft T to be parallel to the horizontal plane, the open-ended periphery R2 of the outer rotor R will be unstably rotated to cause serious vibration. So, it is especially not suitable to be a driving motor where a horizontally oriented shaft is required.

The present inventor has found the drawbacks of the conventional motor with outer rotor, and invented the present electric motor for preventing vibration.

### SUMMARY OF THE INVENTION

The object of the present invention is to provide an electric motor including: an inner stator coaxially mounted on a central stem of a stator holder, an outer rotor having a cylinder member secured with a magnetic conductor in the cylinder member and circumferentially disposed about the inner stator, with the open-end periphery of the cylinder member of the outer rotor stably rotatably supported on a bearing annularly retained on the stator holder, a driving shaft coaxially secured on a central portion of the outer rotor and rotatably mounted in a housing combined with the stator holder, thereby forming an electric motor stably rotated for preventing vibrational shock in order for making a motor with higher torque, house power, stability and efficiency.

### DESCRIPTION OF THE DRAWINGS

FIG. 1 is an exploded view showing the major elements of the present invention.

FIG. 2 is a perspective view of the present invention when assembled.

FIG. 3 is a longitudinal sectional drawing of the present invention.

FIG. 4 is a cross sectional drawing when viewed from 4-4 direction of FIG. 3.

FIG. 5 is a cross sectional drawing as viewed from 5-5 direction of FIG. 3.

FIG. 6 is an enlarged view from FIG. 3.

FIG. 7 shows another preferred embodiment of the present invention.

FIG. 8 shows still another preferred embodiment of the present invention.

FIG. 9 shows further preferred embodiment of the present invention.

FIG. 10 shows still further preferred embodiment of the present invention.

FIG. 11 is a sectional drawing of a conventional electric motor with outer rotor.

### DETAILED DESCRIPTION

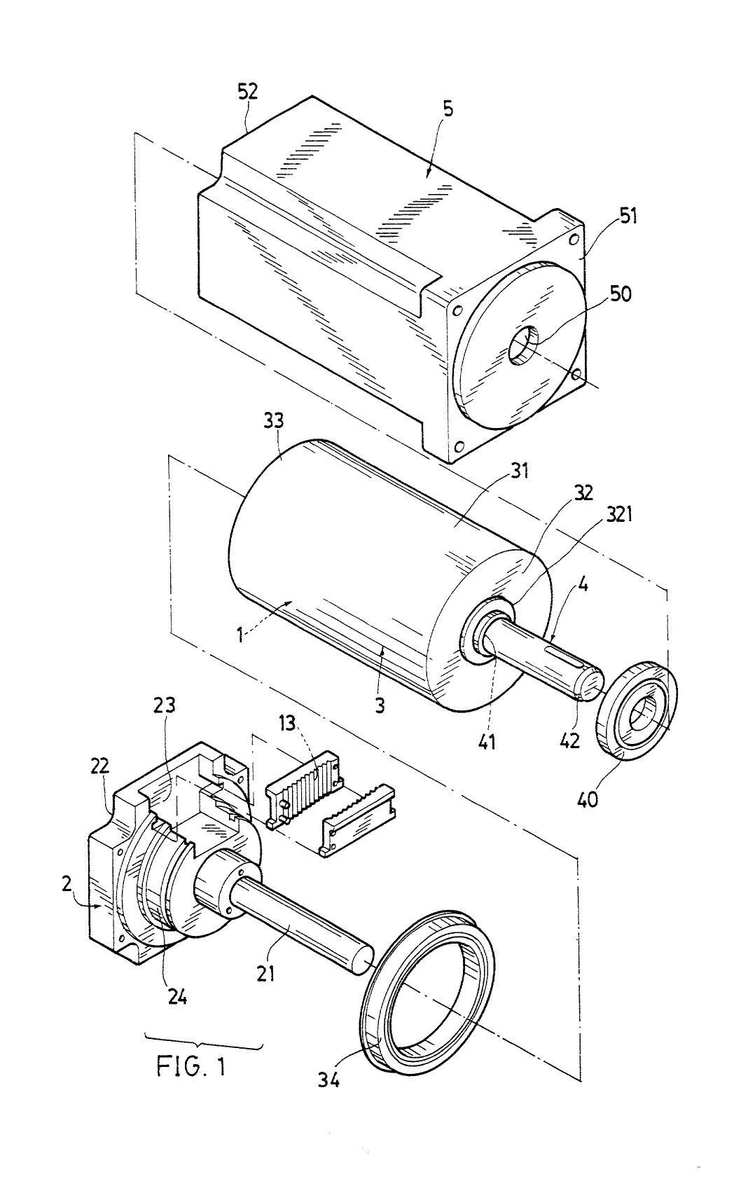

As shown in FIGS. 1˜6, the present invention comprises: an inner stator 1, a stator holder 2 for mounting the inner stator 1 thereon, an outer rotor 3 circumferentially disposed around the inner stator 1, a driving shaft 4 coaxially secured with the outer rotor 3, and a housing 5 combined with the stator holder 2 for encasing the outer rotor 3 and the inner stator 1 within the housing 5.

The inner stator 1 includes: a stator yoke or core 11 coaxially secured to a central stem 21 of the stator 2 about a longitudinal axis X defined at a longitudinal center of the stem 21 of the stator holder 2, having magnetizing windings 12 wound on the stator core (yoke) 11 and electrically connected to an external control circuit of power source through electric wires 13 passing through a wire passage 23 formed in the stator holder 2. Suitable electric insulators are provided between the core 11 and the stator holder 2.

The stator holder 2 includes: the central stem 21 protruding outwardly from a base 22 of the stator holder 2, with the base 22 combinable with the housing 5 for encasing the stator 1 and the rotor 3 within the housing 5 and the holder 2.

The outer rotor 3 includes: a cylinder member 31 circumferentially disposed around the inner stator 1 and a magnetic conductor 30 secured to an inside wall of the cylinder member 31.

The magnetic conductor 30 may be made of permanent magnet, hysteresis ferromagnetic material, or any other materials which are magnetically conductive and may interact with the inner stator 1 to cause rotation of the outer stator 3 due to armature reaction between the inner stator 1 and the outer rotor 3.

The cylinder member 31 of the outer rotor 3 includes: a closed end plate 32 formed on a first end of the cylinder member 31 having a central hub portion 321 coaxially secured with the driving shaft 4 about the longitudinal axis X of the central stem 21 of the stator holder 2, an open-end periphery 33 formed on a second end of the cylinder member 31 opposite to the closed-end plate 31 and rotatably engageable with the base 22 of the stator holder 2 by means of a bearing 34 annularly formed between the open-end periphery 33 of the cylinder member 31 and the base 22.

The base 22 of the stator holder 2 is annularly formed with a bearing groove or retaining portion 24 for fixing the bearing 34 therein for rotatably engaging and supporting the open-end periphery 33 of the cylinder member 31 of the outer rotor 3 for increasing the rotation stability of the rotor 3 in the present invention and for preventing or minimizing vibrational shock caused during the rotation.

The driving shaft 4 is rotatably mounted through a shaft hole 50 formed in a central portion of a closed-end plate 51 of the housing by shaft bearing 40, having an inner end portion 41 of the shaft 4 coaxially secured with the central hub portion 321 of the cylinder member 31 of the outer rotor 3 about the longitudinal axis X, and an outer end portion 42 connected to any operational machine (not shown) driven by the motor of the present invention.

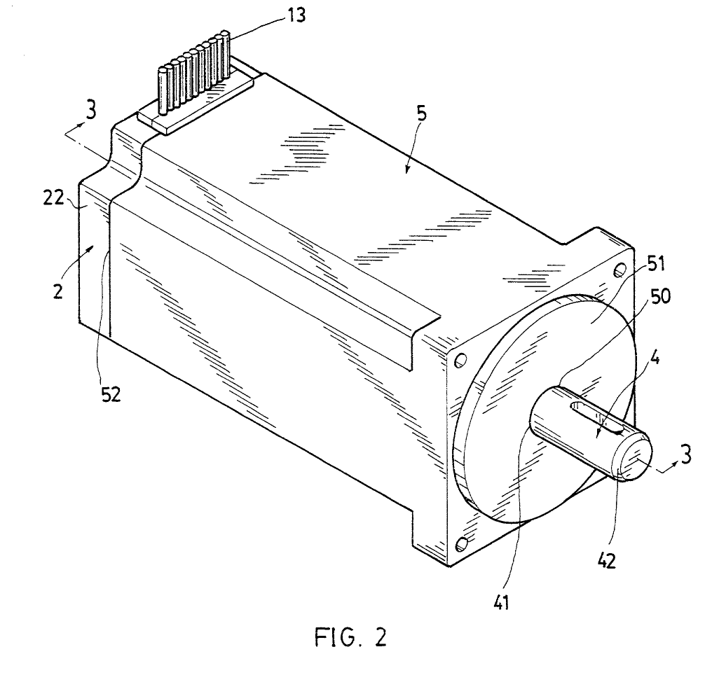

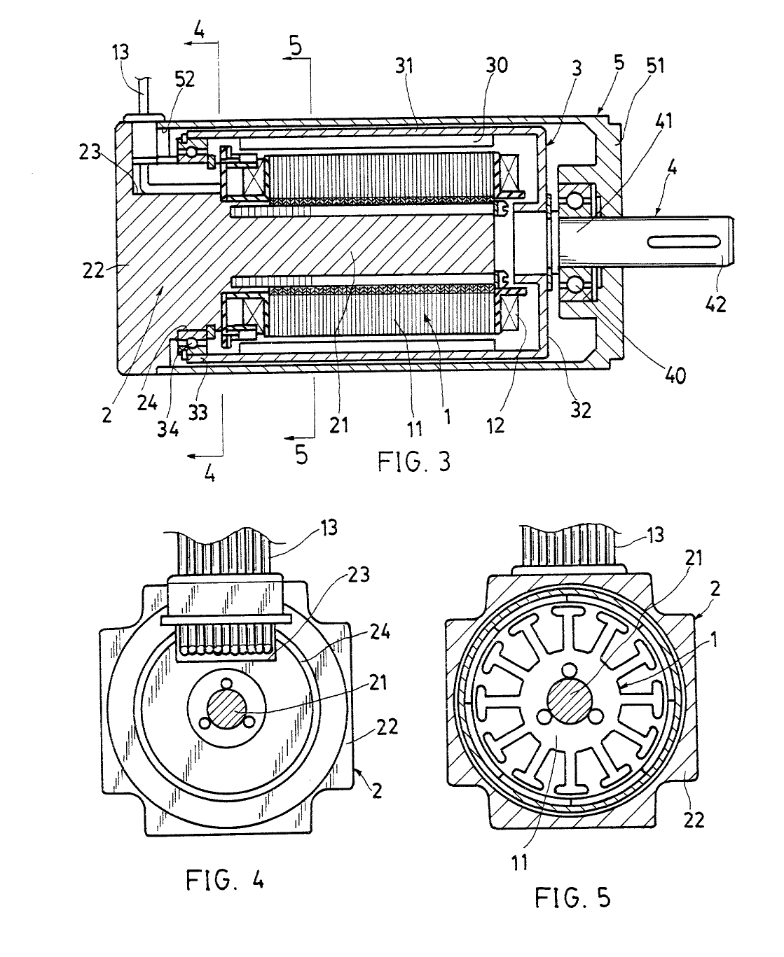

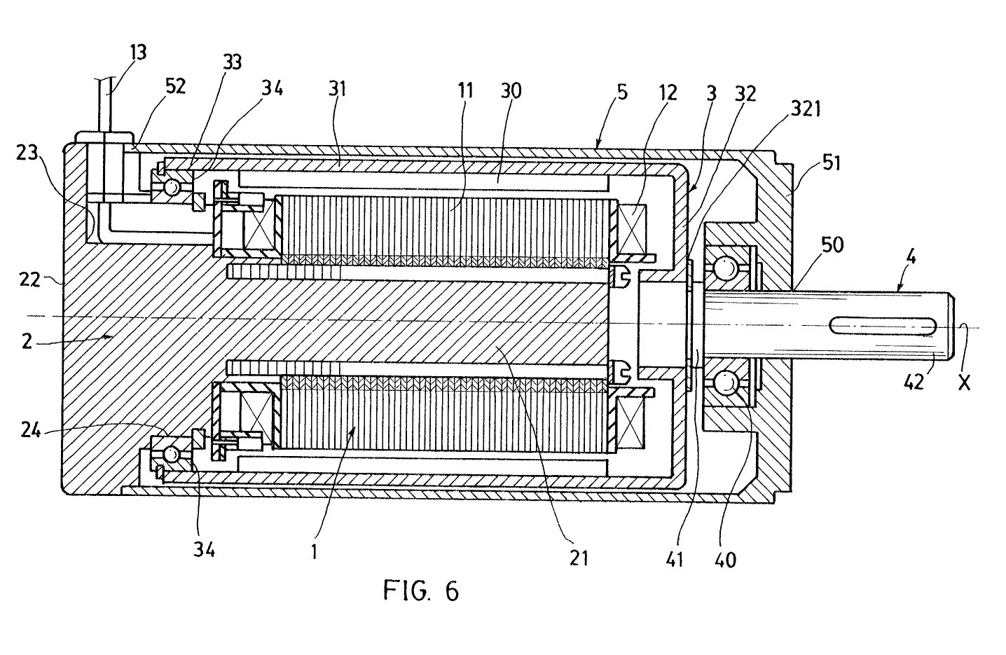

The housing 5 has an open-end periphery 52 formed on a free end of the housing 5 opposite to the close-end plate 51 to be combined with the base 22 of the stator holder 2 for encasing the inner stator 1 and the outer rotor 3 within the housing 5 (FIGS. 2 and 6).

The housing 5 may be formed with flat side or bottom walls to be stably placed on a working place or platform when horizontally laying down the motor of the present invention for its operation.

The materials and mechanisms for making the stator 1 and the rotor 3 are not limited in the present invention, and may be modified by those skilled in the art for making electric motors.

Upon powering of the windings or coils 12 of the stator 1 to magnetize the inner stator 1, the outer rotor 3 corresponding to the inner stator 1 will be magnetically conductive and will interact with the inner stator 1 to cause a rotation and exert a torque on the outer rotor 3 due to armature reaction between the inner stator 1 and the outer rotor 3. The shaft 4 is coaxially secured with the central hub portion 321 of the cylinder member 31 of the outer rotor 3 and will be rotated synchronously with the rotation of the outer rotor 3.

Since the open-end periphery 33 of the outer rotor 3 is rotatably engageable with and supported on the bearing 34 on the base 22 of the stator holder 2, the cylinder member 31 of the outer rotor 3 will thus be stably rotated without vibration, thereby preventing or minimizing the vibrational shock of the motor.

Accordingly, the vibration, caused by the interaction between the inner stator 1 and the outer rotor 3 or caused by centrifugal force when rotated under higher speed, will then be prevented or minimized by the mechanism of the present invention since the open-end or free-end periphery 33 of the cylinder member 31 of the outer stator 3 has been rotatably supported on the base of the stator holder 2 which is also stably combined with the housing 1.

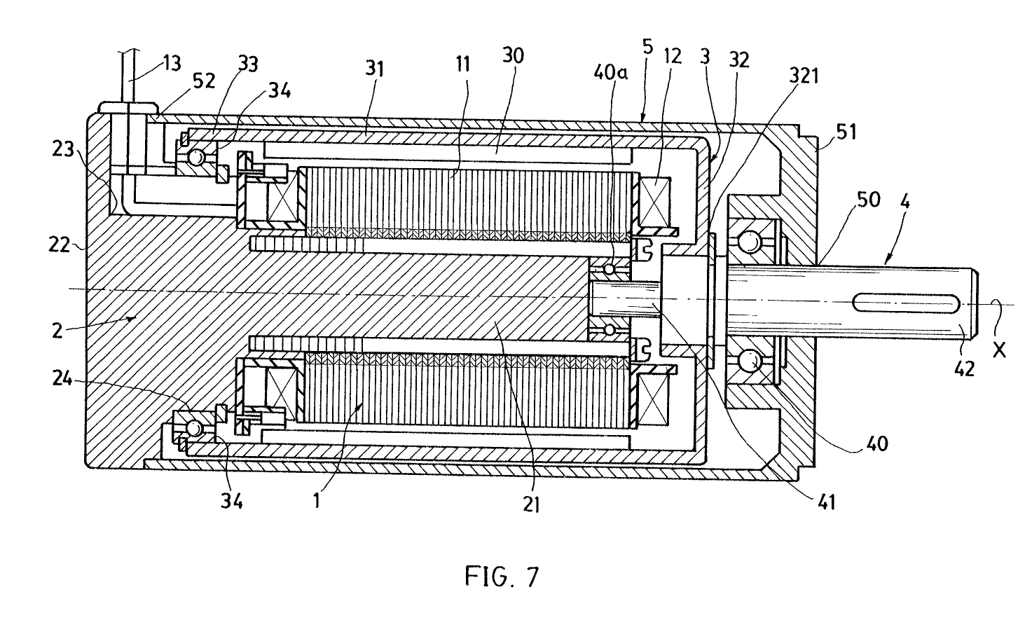

As shown in FIG. 7, the driving shaft 4 has its inner end portion 41 protruding inwardly from the central hub portion 321 of the cylinder member 31 of the outer rotor 3, with the inner end portion 41 of the shaft 4 rotatably engageable with an auxiliary shaft bearing 40a retained on the central stem 21 of the stator holder 2.

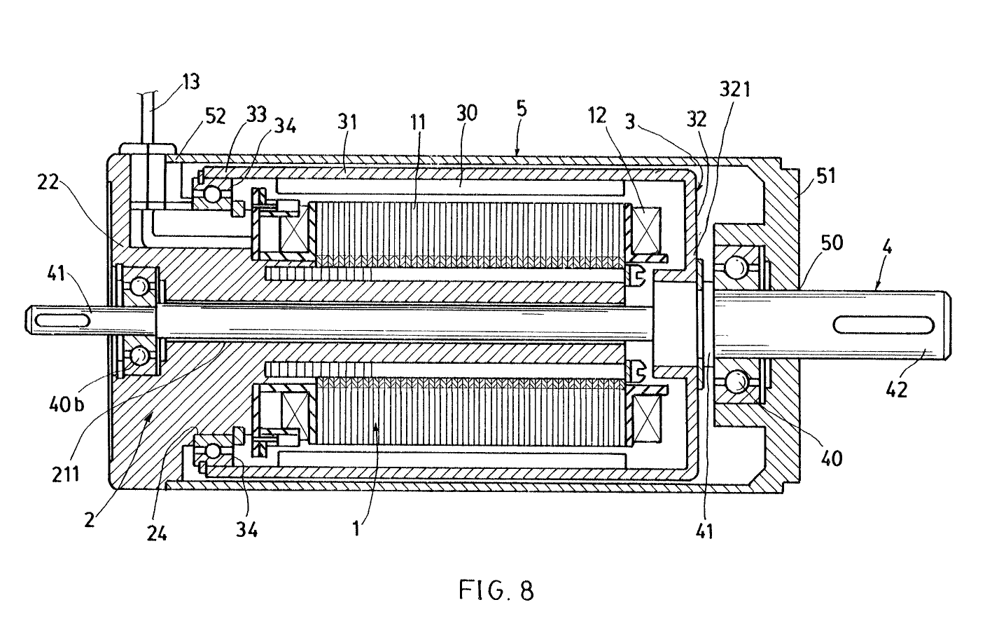

As shown in FIG. 8, the inner end portion 41 of the shaft 4 is remotely protruded from the central hub portion 321 of the cylinder member 31 of the outer rotor 3 through an axle hole 211 longitudinally formed through the central stem 21 of the stator holder 2 to be rotatably supported on and engageable with an auxiliary bearing 40a retained in a base 22 of the stator holder 2. The inner end portion 41 of the shaft 4 may be provided for driving an encoder of a control system (not shown).

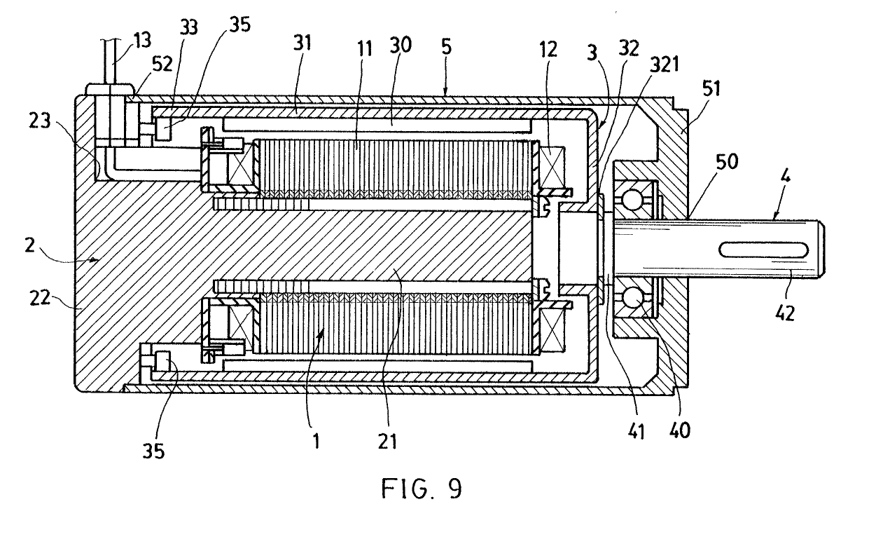

As shown in FIG. 9, the bearing 34 as shown in FIG. 6 has been substituted with a plurality of rollers or wheels 35 rotatably mounted on the base 22 of the stator holder 2.

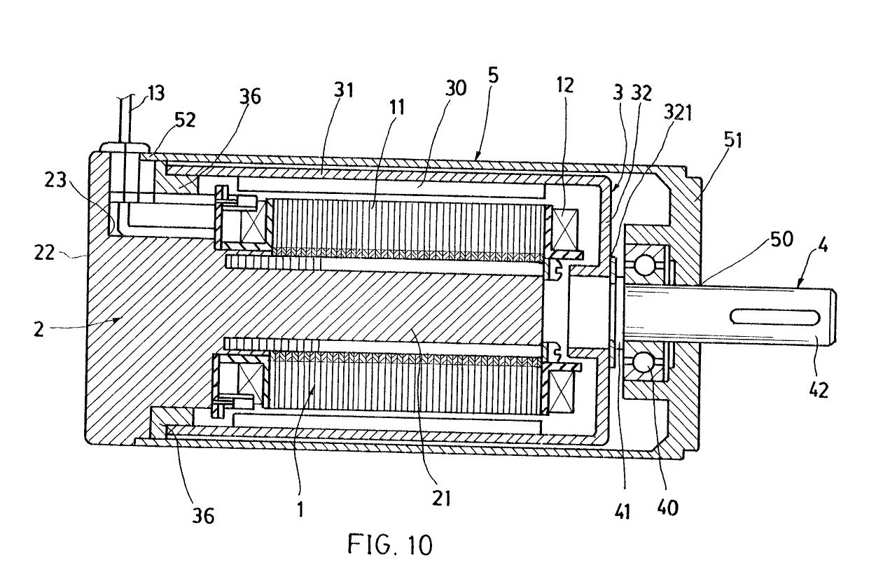

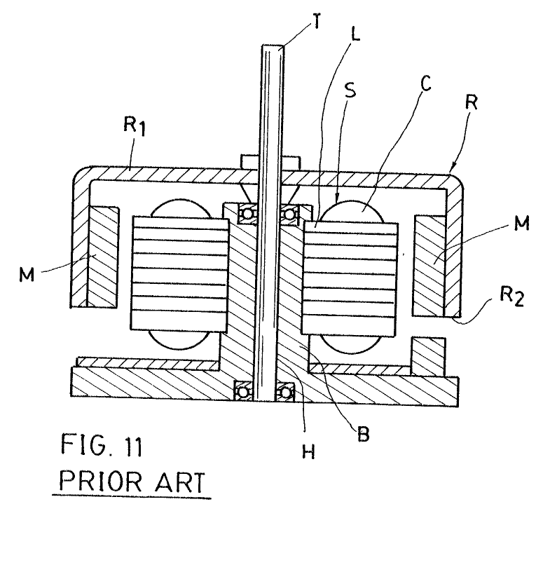

As shown in FIG. 10, a self-lubricating bearing ring 36 may be provided to replace the bearing 34 as shown in FIG. 6 of the present invention. The self-lubricating bearing ring 36 may be retained on the base 22 of the stator holder 2 and may be shielded by the periphery 52 of the housing 5 as shown in FIG. 10.

The self-lubricating bearing ring 36 may be an oil-impregnated bearing ring which may be made of powder metallurgy and impregnated with lube oil in the ring. The bearing 34, the rollers 35 or the self-lubricating bearing ring 36 may be defined as the bearing means in the present invention.

Other modifications may be made without departing from the spirit and scope of the present invention. The magnetic conductor 30 and the cylinder member 3 1 may be integrally formed together.

The present invention is superior to the conventional electric motor (having an outer rotor) with the following advantages:

1. The free end or open end of the rotor cylinder of the outer rotor has been stably supported on a bearing means (34, 35, 36) retained on the stator holder 2 in the housing 5, thereby preventing or minimizing the vibrational shock caused during the motor rotation.

2. Due to the prevention of vibrational shock as effected by the present invention, an output of higher horsepower or torque of the motor may be achieved by the present invention, increasing the motor efficiency and industrial value thereof.

3. The rotor cylinder 31 has been stably supported so that the motor may be horizontally laid down on a horizontal platform for rotating the shaft along an axis parallel to a horizontal plane. So, the motor may be erected vertically or horizontally laid down for a convenient installation and utilization.

4. By increasing the intensity of the magnetic field and increasing the diameter of the outer rotor 3, a higher torque may be produced in order to make a motor of high horsepower, high torque and high stability.

I claim:

1. An electric motor comprising:
an inner stator having magnetizing windings wound on a stator core secured on a stator holder and electrically connected to an external control circuit of power source;
an outer rotor having a cylinder member circumferentially disposed around said inner stator, and a magnetic conductor secured on an inside wall of the cylinder member and made of magnetically conductive material for interaction with said inner stator when magnetized to cause rotation of said outer rotor due to armature reaction between the inner stator and the outer rotor;
a driving shaft coaxially secured with said outer rotor for a synchronous rotation of the shaft when the outer rotor is rotated; and
a housing combined with said stator holder for encasing said outer rotor and said inner stator therein, having a shaft bearing provided in said housing for rotatably mounting said shaft in said housing, with said shaft protruding outwardly from said housing;
the improvement which comprises:
said cylinder member of said outer rotor including: a closed end plate formed on a first end of the cylinder member having a central hub portion on said close-end plate coaxially secured with the driving shaft about a longitudinal axis of a central stem of the stator holder, an open-end periphery formed on a second end of the cylinder member opposite to the closed-end plate and rotatably engageable with a base of the stator holder by a bearing means annularly formed between the open-end periphery of the cylinder member and the stator holder.

2. An electric motor according to claim 1, wherein said bearing means is at least a bearing annularly retained on a retaining portion annularly formed on the base of the stator holder.

3. An electric motor according to claim 1, wherein said bearing means includes a plurality of rollers each rotatably mounted on the base of said stator holder.

4. An electric motor according to claim 1, wherein said bearing means includes a self-lubricating bearing ring.

5. An electric motor according to claim 4, wherein said self-lubricating bearing ring is an oil-impregnated bearing ring.

6. An electric motor according to claim 1, wherein said cylinder member is integrally formed with said magnetic conductor.

7. An electric motor according to claim 1, wherein said magnetic conductor includes at least a permanent magnet.

8. An electric motor according to claim 1, wherein said housing includes a closed-end plate having a shaft hole formed in a central portion of the closed-end plate for protruding the driving shaft outwardly therethrough, and an open-end periphery of the housing combinable with the base of said stator holder for encasing said inner stator and said outer rotor within said housing.

9. An electric motor according to claim 1, wherein said driving shaft has an inner end portion thereof protruding inwardly from a central hub portion of the cylinder member of the outer rotor, with the inner end portion of the shaft rotatably engageable with an auxiliary shaft bearing retained on a central stem of the stator holder.

10. An electric motor according to claim 1, wherein an inner end portion of the shaft is remotely protruded from a central hub portion of the cylinder member of the outer rotor through an axle hole longitudinally formed through a central stem of the stator holder to be rotatably supported on and engageable with an auxiliary bearing retained in the base of the stator holder.
